(19) United States
(12) Patent Application Publication
(10) Pub. No.: US 2005/0192891 A1
(43) Pub. Date: Sep. 1, 2005

(54) System and method for providing access to detailed payment experience

(75) Inventors: Richard A. Ferrera, Macungie, PA (US); Norman Bahnck JR., Fogelsville, PA (US)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: Dun & Bradstreet, Inc.

(21) Appl. No.: 10/788,679

(22) Filed: Feb. 27, 2004

(51) Int. Cl. G06F 17/60

(52) U.S. Cl. 705/38

(57) ABSTRACT

A system and method for providing access to detailed payment experience includes a data acquisition component, a data calculation component, a data synthesis component, and at least one storage device. The data acquisition component captures detailed trade data from various sources. The data storage component calculates a plurality summarized variables and a manner of payment and a high credit amount based on the detailed trade data. The data synthesis component calculates a plurality of scores using the trade variables. The detailed trade data, summarized variables, and scores are stored for various time periods, such as 3-month, 6-month, 9-month, 12-month, 16-month and 24-month periods.

### BACKGROUND OF THE INVENTION

1. Field of the Invention

The present disclosure generally relates to providing business information. In particular, the present disclosure relates to a system and method for providing access to detailed payment experiences.

2. Description of Related Art

In the 1970s, businesses made one-off phone calls. A one-off phone call was made, for example, when a retailer wanted to buy a quantity of products from a manufacturer. When the retailer wanted to purchase on, say, thirty day terms, the manufacturer asked who else the retailer had bought from on thirty day terms so that the manufacturer could call them as a credit reference. At this time, trade reports were created by reporters in field offices who interviewed businesses, collected references, and made one-off calls and then summarized the information. This required a large infrastructure to capture the estimated 2.5 million trade experiences.

Later, companies used reel-to-reel tapes to store trade payment data and business information providers collected the trade data tapes and reformatted them to create reports. Processing thousands of records at a time on trade tapes was an improvement over making one-off calls, but the trade payment experiences presented dollar amounts with days beyond terms as summarized over the last twelve months. There is a need for a detailed payment experience in a report that summarize the data at a level less than twelve months, e.g., three months, six months, or nine months.

Traditionally, payments experiences covered a twelve month period of time. However, customers now desire shorter time intervals, because a company could have paid its bills nine, ten, or eleven months ago promptly so that the average over twelve months came out prompt or not too bad, when in recent months the company was delinquent. There is a need for a way to show a company's ability to pay its bills during periods of time other than the traditional twelve month period of time. Also, there is a need to warehouse trade data to enable such views over different time periods.

In addition, there is a need for customers to have access to payment experience details that are currently unavailable. Critical information in accounts receivable files are collected today, but this information is not used, due to legacy systems and business decisions made over the past twenty years or so. There is a need to mine these details, store the data, and make it available to customers.

### BRIEF SUMMARY OF THE INVENTION

The present disclosure is directed to a system and method for providing access to a detailed payment experience that satisfies these needs.

A first aspect of the present disclosure is a system for providing access to detailed payment experience comprising at least one processor and at least one storage device. The processor captures detailed trade data from a plurality of sources, calculates a plurality summarized variables and a manner of payment and a high credit amount based on the detailed trade data, calculates a plurality of scores using the summarized variables, and provides a report using the detailed trade data, the summarized variables, and the scores. The storage device stores and provides access to the detailed trade data, summarized variables, and scores. In some embodiments, the summarized variables are computed for a time period selected from the group consisting of: 3-months, 6-months, and 9-months. In some embodiments, the manner of payment and the high credit amount are calculated for a 24-month period. In some embodiments, the scores are calculated for a time period selected from the group consisting of: over a 3-months, 6-months, 9-months, 12-months, and 16-months.

A second aspect of the present disclosure is a system for providing access to detailed payment experience, comprising a data acquisition component, a data storage component, a data synthesis component, at least one storage device, and a reporting component. The data acquisition component is for capturing detailed trade data from various sources. The data storage component is for calculating a plurality summarized variables and a manner of payment and a high credit amount based on the detailed trade data. The data synthesis component is for calculating a plurality of scores using the trade variables. The storage device(s) is for storing and providing access to the detailed trade data, the summarized variables, and the scores. The reporting component is for providing a report using the detailed trade data, the summarized variables, and the scores.

A third aspect of the present disclosure is a method for providing access to detailed payment experience that is capable of being stored in instructions on a computer-readable medium, such as a CD. Detailed trade data is captured from various sources. A plurality of summarized variables and a manner of payment and a high credit amount are calculated based on the detailed trade data. A plurality of scores are calculated using the trade variables. Detailed trade data, the summarized variables, and the scores are stored and access is provided to them. A report is provided using the detailed trade data, the summarized variables, and the scores.

In some embodiments, the summarized variables are computed for various time periods of 3-months, 6-months, and 9-months. In some embodiments, the manner of payment and the high credit amount are calculated for a 24-month period. In some embodiments, the scores are calculated for various time periods of 3-months, 6-months, 9-months, 12-months, and 16-months. In some embodiments, the system also comprises a data quality and reporting component for refining data in the storage devices based on quality criteria. In some embodiments, the scores include an industry-specific score and a credit-range-specific score. In some embodiments, the storage device(s) is one or more of: a detailed trade data warehouse; a product trade data mart; and an analytical trade data mart. In some embodiments, the report comprises data selected from the group consisting of: a summary, a dollar-weighted indicator of payment performance, a trend analysis, and payment experiences.

### BRIEF DESCRIPTION OF THE DRAWINGS

These and other features, aspects, and advantages of the present disclosure will become better understood with regard to the following description, appended claims and accompanying drawings where

FIG. 1 is a block diagram of an example process for providing trade data;

FIG. 2 is a block diagram of an example system for providing detailed payment experience;

FIG. 3 is a block diagram of example functional subsystems of a system for providing detailed payment experience; and

FIGS. 4A, 4B, 4C, 4D, and 4E are example reports showing detailed payment experience.

### DETAILED DESCRIPTION OF THE INVENTION

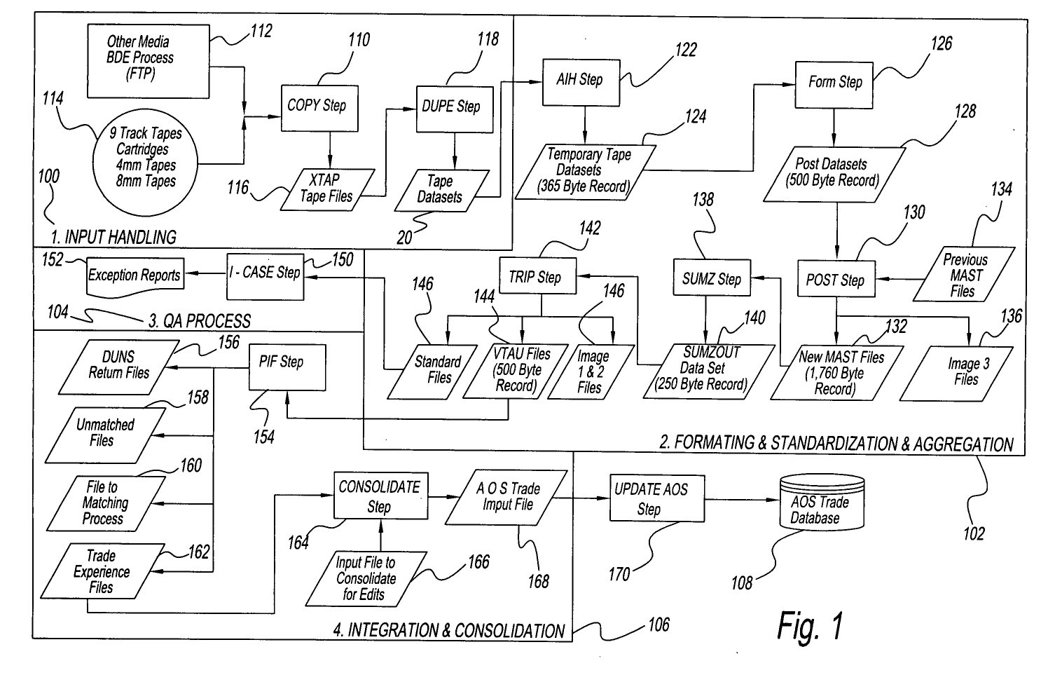

FIG. 1 shows an example process for providing trade data. There are four phases: (1) the input handling phase 100, (2) the formatting, standardization, and aggregation phase 102, (3) the quality assurance (QA) processing phase 104, and (4) the integration and consolidation phase 106. The resulting trade data is stored in an advanced office system (AOS) trade database 108. As an overview, customer supplied trade information is received in various types of media and processed through an input handling phase. The processed data is read into a specific format and aggregated into trade experience data. The data is validated in a quality assurance process supplemented by investigations based on an exception report. The validated data is integrated into databases that are used to deliver products. A typical trade experience data product is a summary of payment behavior of a company over a twelve-month period as well as a snapshot of current standing.

During the input handing phase 100, various types of media (i.e., electronic, tape) having customer supplied trade information are processed through a bulk source tracking system (BST) and automated input handling (AIH) step. The customers that supply trade information are also known as participants, suppliers, and voluntary trade authorities (VTA or VTAU). The media from the participants is copied into tape files and then converted to sequential files using a dupe process. BST is an interface that allows for the tracking of media and is used as input to a trade process. BST is used to track media as well as to track the status of data supplied on the media through a trade system.

In a copy step 110, a program analyst copies media 112, such as tapes and cartridges 114. The purpose of copy step 100 is to copy the entire file as it appears on the tape or cartridge. The physical media is mounted on a computer drive, the file is copied, and the data set is cataloged as an xtap 116.

The next step after the xtap is created is a dupe step 118, which separates the file into individual records, while lining up each field on the file. Xtap 116 is brought in, the file is separated into individual records, the file is copied, and the data set is cataloged as a tape 120.

During the formatting, standardization, and aggregation phase 102, the processed data is read into a common standard format and aggregated into trade experience data.

An AIH step 122 stores specification and control data from tape datasets 120 for each VTA in a single file called an AIH specs master file and generates temporary tape datasets 124.

A form step 126 is used in conjunction with AIH step 122 to perform validation and reformatting on input trade data and then produce a record 128 to be passed to the post step 130 so that trade data can be compared and merged with information from previous processing in the post step 130.

A post step 130 posts current amount owing data from record 128 to a cumulative file called the mast files 132, which contain up to twelve months of data for all accounts that belong to each VTA. During the post step 130, the oldest month in the mast files 132 are deleted and the latest month is added. The mast files 132 include data from previous mast files 134 and is used to determine a high credit among owing, past due, and payment experience. Also, image files are generated 136. Following the post step 130, is a summarizer step 138.

The summarizer step 138 summarizes the cumulative trade data in the mast files 132 and calculates the payment experience, including high credit, amount owing, past due, and payment experience for output 140. The payment experience is stored in AOS trade database 108.

The trip step 142 uses output 140 and generates a payment performance profile report and creates a voluntary trade authority update (VTAU) dataset 144 along with a standard file 146 and images 148. The VTAU dataset 144 contains the seven base elements used in the AOS trade database 108. Images 148 provide summary statistics. The VTAU dataset 144 and images 148 are used for validation and are sometimes provided to participants. The trip step 142 also converts all dollar amounts and derived variables into corresponding date of experience (DOE) codes and applies account number special handling (ANSH) to exercise overrides on certain accounts as directed by an AIH table for supplier specific data. The VTAU dataset 144 is sent to the trade database for updating the trade experience into various products.

During the QA processing phase 104, data is validated via an automated process supplemented by a manual process based on exceptions that are generated. These exceptions are used as a quality control measure. The investigation-case (i-case) step 150 processes the standard file 146 and creates exception reports 152 periodically. The exception reports 152 provide participant-level summary statistics.

During integration and consolidation phase 106, a participant index file (PIF) step 154 uses the VTAU dataset 144 which has data that passed validation. PIF step 154 does matching and fulfillment for products. The PIF is a database that stores account number and case linkage. The PIF step 154 matches data to unique entity identifiers, such as DUNS Numbers caches data to provide temporary storage for further processing. The PIF step 154 also sends unmatched accounts for scanning and assignment of unique identifiers and keeps track of changes from modify transactions. The PIF step uses DUNS return files 156, unmatched files 158, and a file to matching process 160. The result of the PIF step 154 is trade experience files 162, which are input into a consolidation step 164. The consolidation step 164 consolidates the trade experience data across unique identifiers within each of the trade participant data sets to a predetermined number of trades per unique identifier. Branch level trade is replicated to head-quarters levels and block identifiers are applied. The consolidation step 164 generates an input file to consolidate for edits 166 and an AOS trade input file 168. The AOS trade input file is input for the update AOS step 170, which feeds data into AOS trade database 108.

The consolidate step 164 consolidates the trade experience files 162 across unique case identifiers within each of the trade participant datasets and uses an input file to consolidate for edits 166. This step consolidates trade to a predetermined number of trades per unique case identifier and replicates branch level trade to head quarters level. Also, block unique identifiers are applied and various operations are performed to produce the resulting AOS trade input file 168, which feeds the AOS trade database 108.

In summary, the process in FIG. 1 collects, synthesizes, and distributes trade and payment information to create a summary and twelve month view that is used to evaluate customer credit-worthiness. Trade experiences, such as invoice or summarized account-level data is collected from businesses. The system collates all trade experiences and uses them to derive seven base variables that represent the credit-worthiness of a business. The trade experience data is stored as fixed-length records that are not accessible. The seven base variables are: reporting data, paying record or manner, high credit, now owes, past due, selling terms, and last sale within. These seven base variables evaluate payment habits at a point in time and do not provide historical trending information.

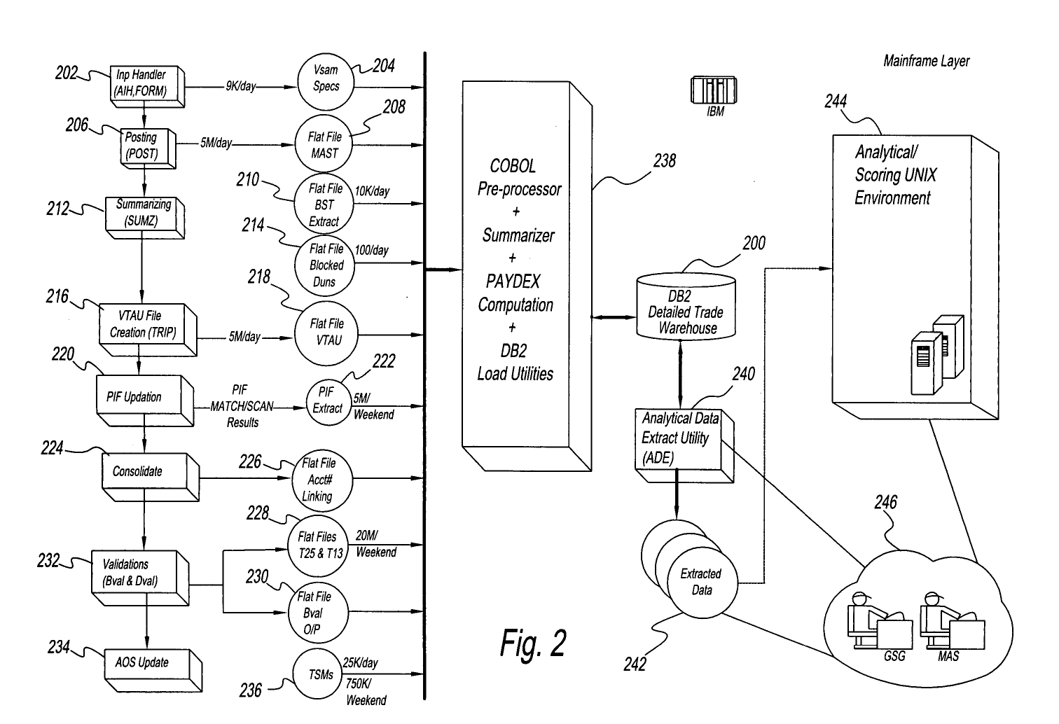

FIG. 2 shows an example system for providing detailed payment experience where all the relevant data is stored in a database, as opposed to the process shown in FIG. 1, where data is reduced to a summary and twelve month view. An example list of detailed trade variables is shown in Table 1 below, which is more inclusive than the seven base variables associated with the process in FIG. 1.

TABLE 1
Example trade variables

| # | Variable Name | Example |
|---|---|---|
| 1 | Date of Exp. | 12/YY |
| 2 | Manner of Payment | Prompt |
| | 12 months | |
| 2a | Manner of Payment | Prompt |
| | 24 months | |
| 3 | Manner of Payment | Prompt to Slow 30 |
| | 9 months | |
| 4 | Manner of Payment | Prompt to Slow 90 |
| | 6 months | |
| 5 | Manner of Payment | Slow 90 to 120 |
| | 3 months | |
| 6 | Derived Categorized | Current = $130,000; Slow 30 = 0; |
| | Pay $s 12 months | Slow 60 = 0; Slow 90 = $10,000; |
| | | Slow 120 = $20,000 |
| | | (can go up to 10 categories) |
| 7 | Derived Categorized | Current = $50,000; Slow 30 = 0; |
| | Pay $s 9 months | Slow 60 = 0; Slow 90 = $10,000; |
| | | Slow 120 = $20,000 |
| 8 | Derived Categorized | Current = $0; Slow 30 = 0; |
| | Pay $s 6 months | Slow 60 = 0; Slow 90 = $10,000; |
| | | Slow 120 = $20,000 |
| 9 | Derived Categorized | Current = $0; Slow 30 = 0; |
| | Pay $s 3 months | Slow 60 = 0; Slow 90 = $10,000; |
| | | Slow 120 = $20,000 |
| 10.1 | High Credit | $40,000 |
| | (over 12 months) | |
| 10.2 | High Credit | $30,000 |
| | (over 9 months) | |
| 10.3 | High Credit | $30,000 |
| | (over 6 months) | |
| 10.4 | High Credit | $30,000 |
| | (over 3 months) | |
| 10.5 | High Credit | |
| | (over 24 months) | |
| 11 | Total Amount Owing | $30,000 |
| 12 | Total Past Due | $30,000 |
| 13 | Current Amount | $0 |
| | Owing | |
| 14 | Past Due 1 to | $0 |
| | 30 days | |
| 15 | Past Due 31 to | $0 |
| | 60 days | |
| 16 | Past Due 61 to | $10,000 |
| | 90 days | |
| 17 | Past Due 120+ | $20,000 |
| 18 | Last Sale | Within 2-3 months |
| 19 | Terms | Net 30 |
| 20 | New Credit | $160,000 |
| | Sales Proxy | |
| | Current 12 months | |
| 24 | New Credit Sales | $???,??? |
| | Proxy | |
| 25 | PAYDEX (3 months) | |
| 26 | PAYDEX (6 months) | |
| 27 | PAYDEX (9 months) | |
| 28 | PAYDEX (12 months) | |

In FIG. 2, the example system has components in the left two columns that are similar to those shown in FIG. 1, because the system captures data from existing legacy processes and stores information from these processes along with other information in a detailed trade warehouse (DTW) 200. In this example, participants use a trade reference number (VTA number) and submit account postings for processing.

An input handler 202 combines automated input handler (AIH) and form steps and generates a spec master file (vsam spec) 204, which is used in the DTW 200 to store information about seven base elements (high credit, amount owing, past due, data of last sale, manner of payment, terms of sale, and date of experience) which are supplied by each participant. Each supplier is associated with a spec master file 204 that includes a twelve month history.

Posting 206 updates the spec master files 204 to create mast files 208 having a twelve month history. This data is stored in the DTW 200 as an account snap shot table along with twenty-four months of data for each supplier and account relation. Bulk source tracking (BST) extract 210 has tracking information, including supplier and status information.

Summarizing 212 summarizes the cumulative trade data and calculates the payment experience. The twelve month history data is read from mast files 208 and additional data, such as 24 months of data is used to calculate the seven base elements for an account snap shot table. Data, including dollar amounts, is stored for a plurality of aging categories, such as view of 3, 6, 9, 12, and 24 months. A blocked duns file 214 includes information about unique identifiers.

Voluntary trade authority (VTAU) file creation 216 is performed by a trip step in the legacy process. The trip step generates a VTAU file 218 that contains the seven base elements used in the AOS trade database 108 along with image files, which include summary statistics. These files are used for validation and are sometimes available to participants. The trip step converts dollar amounts and derived variables into date of experience (DEO) codes and applies account number special handling (ANSH) to exercise overrides on certain accounts as directed by an AIH table for supplier specific data.

In PIF update 220, participants send their accounts receivable files daily and, as the files are received, they are tripped. Files are tripped by taking the data submitted by the VTA and processing for each participant. As the week progresses, files are tripped and the trips are accumulated and held in a PIF extract file 222 and captured in the DTW. The PIF extract file 222 includes the following transactions to maintain account-to-purchaser linkage and match information: match scan results, trade service message system (TSMS) and unique identifier (e.g., DUNS) AOS trade system (DATS) transactions. One day a week, all of the trips that have been created and held during the weekend are processed and validated.

In consolidation 224, a flat file 226 is generated that has account linking information. The output from consolidation 224 also includes T13 and T25 type output 228 and bval 230. T13 type output is delete transactions and are used to delete payment experiences from DTW 200. T25 type output is transactions that contain experiences for a given unique identifier, reference number, and DOE. T25 transactions are used to update the DTW 200. Bval 230 includes account postings from suppliers in the form of trade experiences, after PIF processing. These trade experiences are consolidated into type T25 records and sent for validation 232 during a predetermined time period, such as the weekend. This validation is called bval. Bval also processes Receivable Management Services (RMS) account postings along with T25 and user built transactions. RMS provides a full range of accounts receivable management services.

AOS update 234 updates the DTW 200 with T25 transactions that pass validation. Trade service messages (TSM) 236 are transactions that are sent from or to parts of the trade system for synchronization. While the DTW 200 is updated 238, PAYDEX is calculated for each unique case identifier, in case data changes in the DTW 200 for that unique case identifier. A PAYDEX score is based on reported payments and calculated using a plurality of trade experiences, such as 875 on a business. The PAYDEX score compares payments to terms of sale and is dollar-weighted and scores the overall manner of payment over a rolling predetermined period, such as a 16-month period. The PAYDEX score is provided in many reports, such as a credit scoring report.

Analytical extract utility (ADE) 240 generates extracted data 242 that is accessible by an analytical scoring environment 244 and others, such as global scoring group (GSG) and MAS 246.

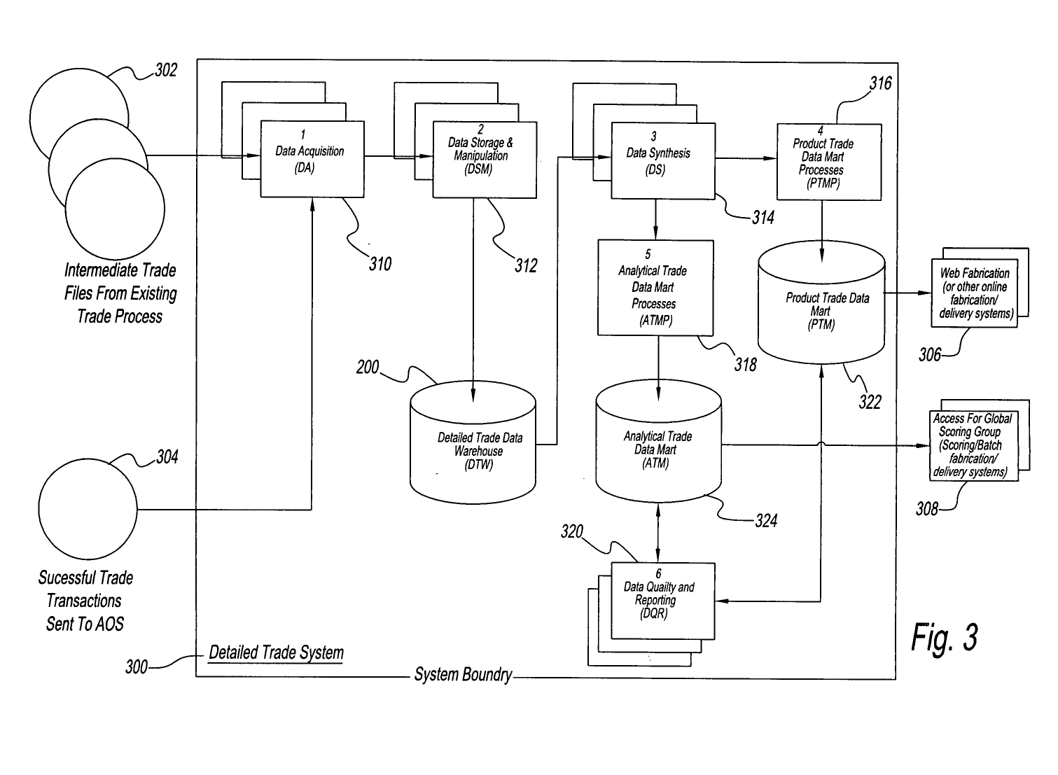

FIG. 3 shows an example functional subsystems of a system for providing detailed payment experience. As an overview, the system builds a trade information repository in order to increase the usefulness of trade information to customers. The trade information repository is built by storing detailed trade data, enabling customer access, and calculating aging details with categorization of balance amounts for trade data. A history of detailed payment information is maintained in the trade information repository.

FIG. 3 shows a detailed trade system 300 that receives intermediate trade files 302 and successful trade transactions 304 that were sent to AOS in the legacy trade process described in FIG. 1. The detailed trade system 300 generates data for web fabrication 306 and other systems and provides access for the GSG 308 and other systems. The detailed trade system 300 has six main components and three storage components. The six main components are: (1) a data acquisition (DA) component 310, (2) a data storage and manipulation (DSM) component 312, (3) a data synthesis (DS) component 314, (4) a product trade data mart (PTMP) component 316, (5) an analytical trade data mart (ATM) component 318, and (6) a data quality and reporting (DQR) 320 component. The three storage components are: the DTW 200, a product trade data mart (PTM) 322, and an analytical trade data mart (ATM) 324.

The DA component 310 captures data from the legacy trade process described in FIGS. 1 and 2. Detailed trade data is captured from the mast files 208, which include DOE, 30-, 60-, and 90-days past due, and slow or aging categories. Summarized data, where detailed data is not provided by a supplier, is captured from the VTAU 218, including the seven elements: DOE, high credit, total amount owing, total past due, payment manner, terms of sale, and last sale within. Summarized data supplied from manual sources, e.g., the seven elements, is captured from the T25 and T13 transaction files 228 and fed into a database update process 238. In addition, the DA component 310 captures non-poster (pre-summarized) trade data from the VTAU 218, which includes the seven elements. TSMs 236 are captured, including transactions for updating accounts on PIF 220. Some examples are a seeding of a unique identifier for an account that was matched, dropping a unique identifier for an account that was dropped, and seeding a successor unique identifier for an account. The AIH specs file 204 is captured periodically, such as nightly or weekly to extract poster-summarizer specs, ANSH overrides, aging labels, and the like. These elements are loaded to the DTW 200 to present a current picture of input handling needed for the supplier, purchaser, or account. The BST extract 210 is captured periodically, such as nightly to extract a submission status to determine whether the file was sent to AOS and the approval code to determine whether the file is under investigation or passed investigation and a reference standard industrial classification (SIC) code. The DA component 310 captures data account opened and credit limit fields from a file created by the AIH 202 and stored on the DTW 200.

In addition, the DA component 310 captures historical trade data for an initial load onto the DTW 200. Twenty-four months of detailed trade data is available from the mast files 208. For trade tapes and manual sources, account postings along with 3-, 6-, 9-, and 12-month views and a 24-month high credit and 24-month manner of payment are calculated from the mast files 208 and loaded onto the DTW 200. AIH specs 204, VTAU files 218, and account postings from RMS are captured and loaded onto the DTW 200 at the initial load. All these files are backed up. An extract of the PIF database 222 is taken at initial load to seed the unique identifiers to the accounts. Subsequently, product mart variables are calculated and the product mart is loaded with accounting postings and variables.

The DA component 310 handles AOS rejects. The trade experiences are sometimes rejected for various reasons, before some experiences qualify for storage in the AOS trade database 108. These AOS rejects are captured and all such experiences are marked on the DRW 200 as not present in the AOS trade database 108.

The DA component 310 captures U.S. trade data from non-U.S. sources. For example, the DTW 200 houses trade data on U.S. companies (including matched and unmatched data) from Canadian trade tape providers.

The DSM component 312 classifies supplier files into the following categories: open invoices, paid invoices, open and paid invoices, age trial balance, or indicative data files. For each supplier, the AIH specs file 204 is captured and the supplier file type is determined, storing a type code on the DTW 200. Calculated variables are summarized 212 based on the file type, including computing 3-, 6-, and 9-month summarized variables and the 24-month manner of payment and high credit.

The DSM component 312 stores historical detailed and indicative data. Historical trade data, both detailed and indicative, is captured as described above with respect to DA component 310.

The DSM component 312 stores and manipulates matched and unmatched data. The DTW 200 stores matched as well as unmatched experiences. The 3-, 6-, and 9-month summarized variables and the 24-month manner of payment and high credit are calculated for both. When a case is matched, a purchaser is associated with the unique identifier and corresponding experiences are transferred to the PTM 322 and the ATM 324. During this transfer, the 3-, 6-, and 9-month summarized variables and the 24-month manner of payment and high credit are computed, although PAYDEX calculations are only for the latest or current month. When a case status changes from matched to unmatched, the corresponding purchaser is removed from the DTW 200 and reflected in the PTM 322 and the ATM 324, deleting all experiences associated with that purchaser.

The DSM component 312 handles U.S. trade data from non-U.S. sources and handles AOS rejects. AOS rejects are possible at four stages in the detailed trade system 300: best of five selection, dval and bval 230 validations, number of postings limit, and database update failure. Consolidate 224 captures the best of five account postings by spinning-off a file containing the account numbers of the account postings that are selected in the best of five consolidation. Account numbers thus captured as fed into the DTW 200 periodically, such as nightly to mark the account postings as sent to AOS. Dval or bval 230 perform validations of tag and content on the account postings coming out of consolidate 224, just before the AOS update 234. All account postings rejected in these validations are stored, but do not go into the DTW 200 and are marked as not available on AOS. In the example system, the AOS update 234 rejects postings if the total number for an account purchaser exceed a predetermined limit, such as 874. The remaining account postings are marked as not available on AOS, are stored in the DTW, and considered in calculating PAYDEX. Database failures cause a mismatch between the AOS trade database 108 and the DTW 200 and are corrected.

The DSM component 312 synchronizes with AOS trade. The detailed trade system 300 brings the PTM 322 in sync with the AOS trade database 108 periodically, such as weekly with respect to all voluntary trade data. Trade from voluntary suppliers is captured daily and updated in the DTW 200. The summarization 212 creates experiences periodically to synchronize updates of account postings to the AOS trade database 108. These postings are updated on the PTM 322 periodically with data collected so that the PTM 322 is in synch with the AOS trade database 108. Account postings from manual sources are captured periodically and the DTW 200 is loaded. Subsequently, the PTM 322 is loaded with these account postings timed so that the AOS trade database 108, the DTW 200, and the PTM 322 are all in sync. Certain trade tapes require ANSH overrides, which are applied to specific accounts on the DTW 200 periodically. Additionally, some files are captured to mark the suppliers or purchasers as blocked and are not available to the PTM 322 until the status is changed.

The DSM component 312 purges the DTW 200. The DTW 200 needs to store a predetermined number of the most current postings for an account, such as the most current 24. At the same time, the DTW 200 ensures removal of old data, such as data older than 30 months. To satisfy these needs, the purge process is executed at a database level and at a reference unique identifier account number level. The AOS trade database 108 purges old experiences. In order to identify which old experiences are deleted from the AOS trade database 108, the DTW 200 marks some experiences as not available in the AOS.

The DSM component 312 has a DATS mechanism. DATS are deletion transactions at the case level from the AOS trade database 108. The DTW 200, ATM 324, and PTM 322 are updated according to DATS in TSM transactions 236.

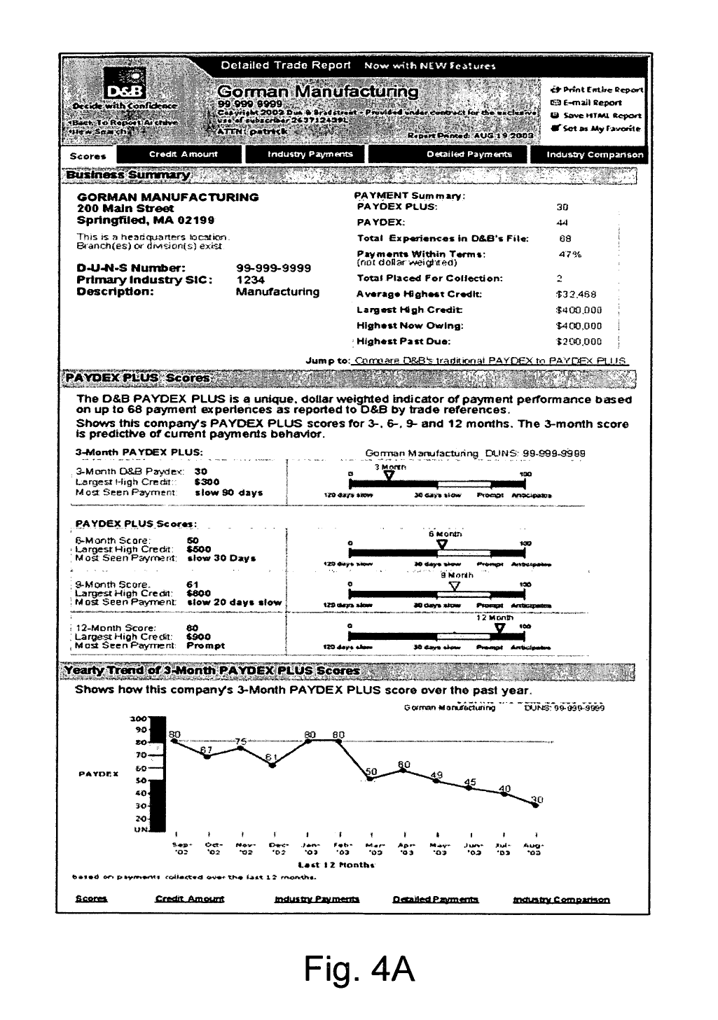

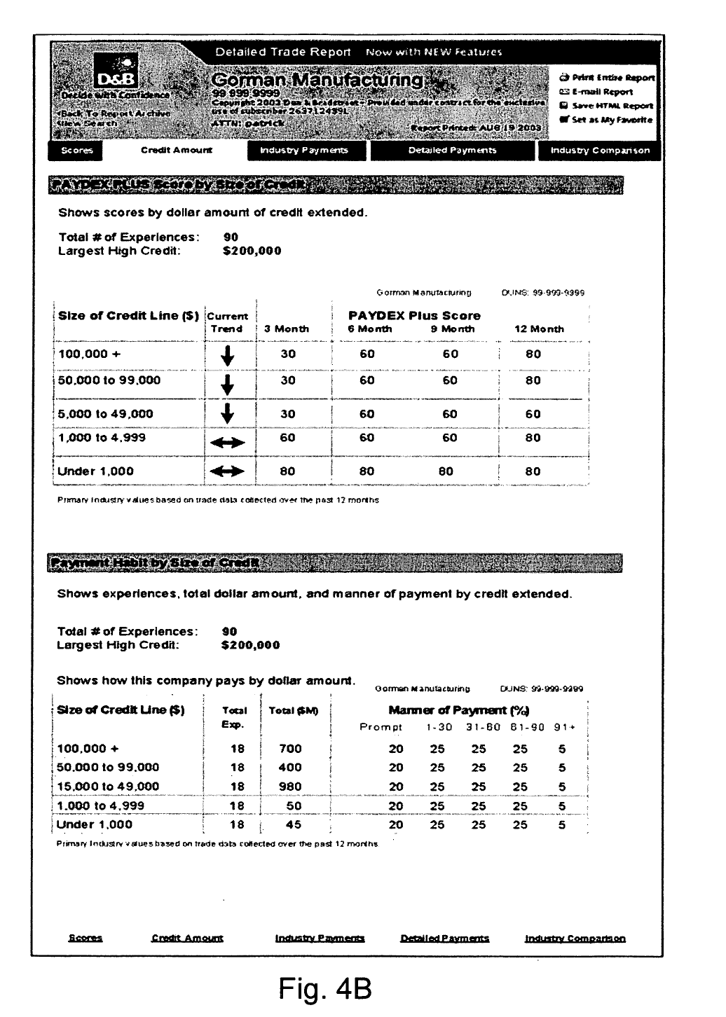

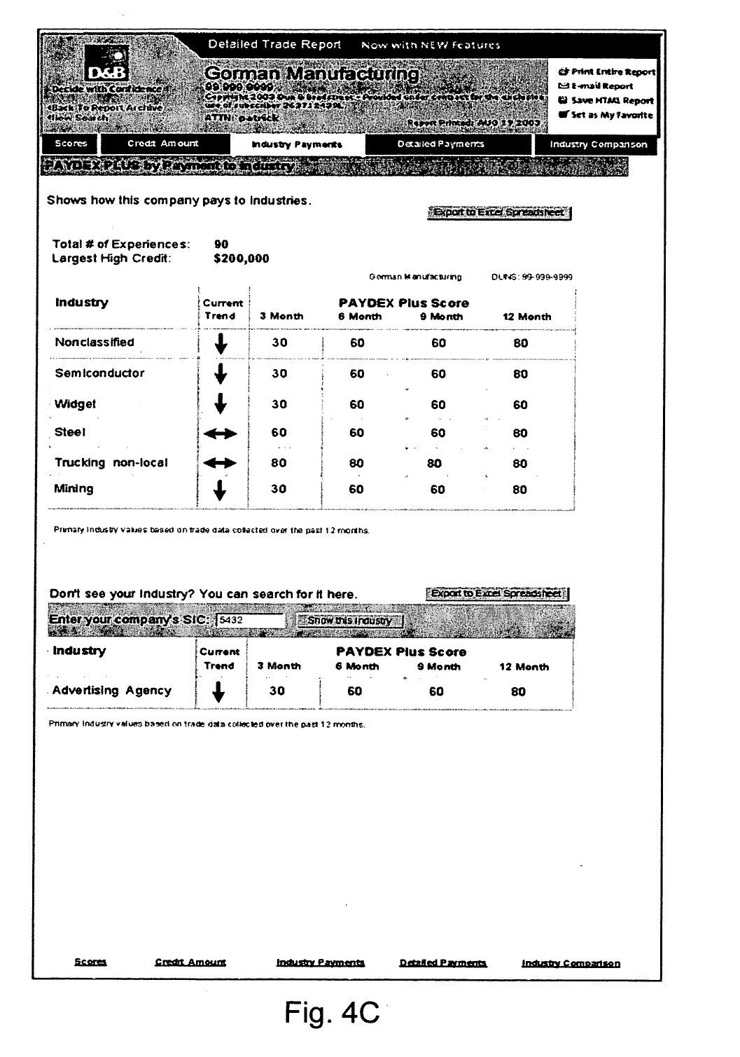

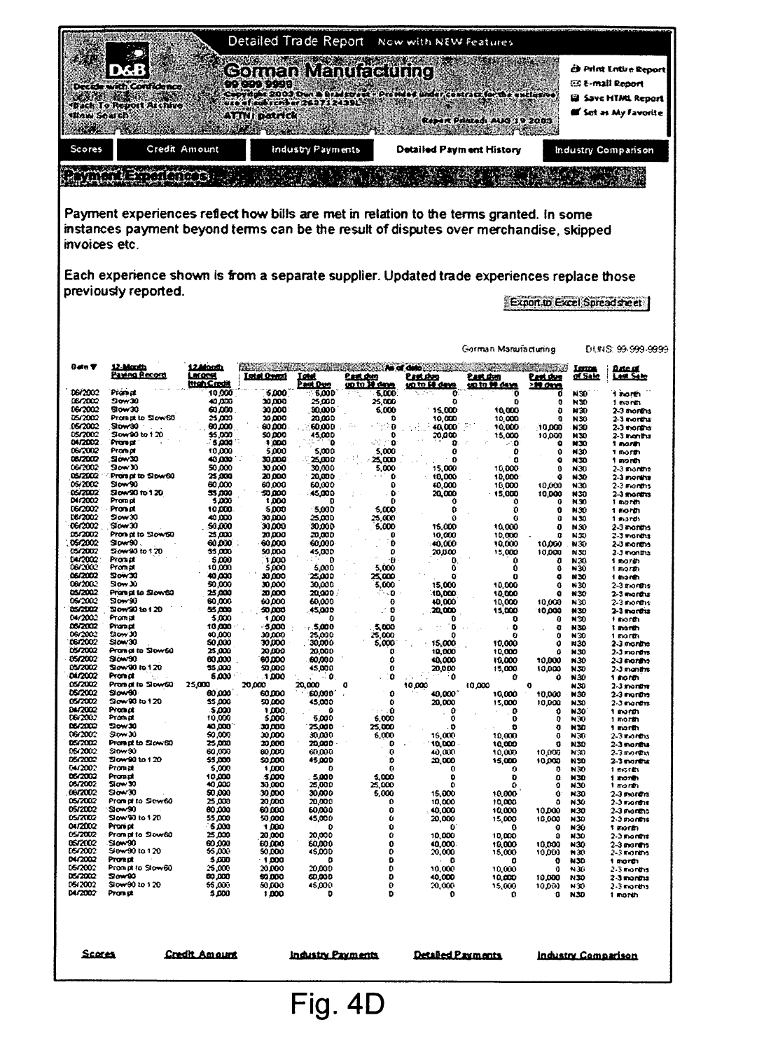

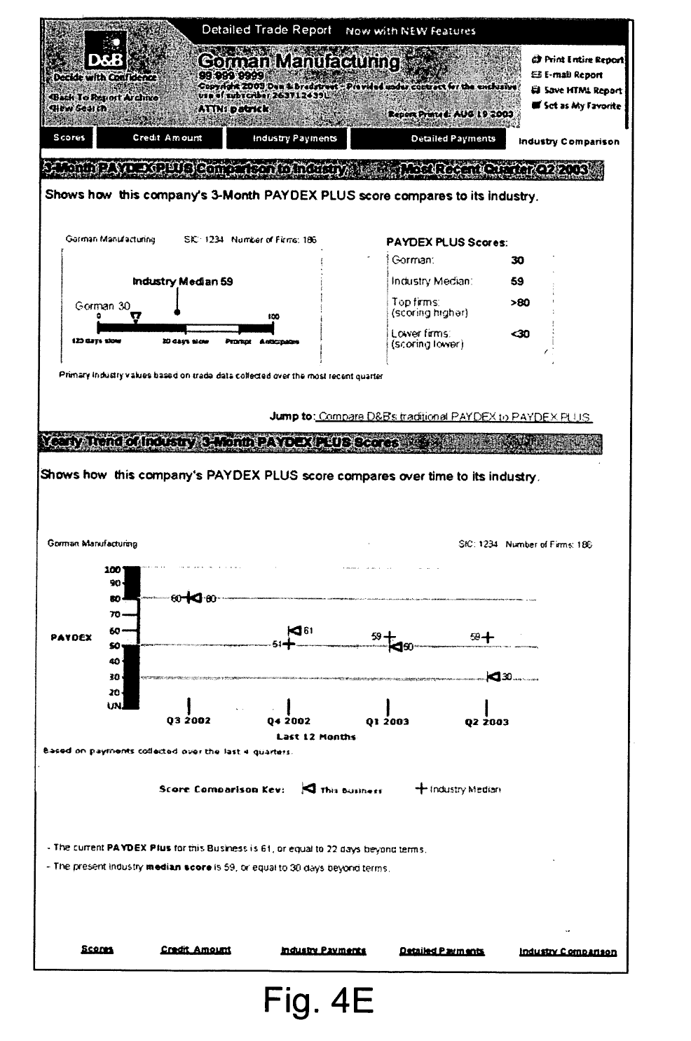

The DSM component 312 performs change detection. Changes to business names and address information on purchaser business as reported by the supplier are accounted for in the DTW 200. Any changes and a change history are maintained as part of the DTW 200. The change detection logic, shown in FIG. 4, is the same for both the DTW and the PIF.

The DSM component 312 performs special handling of linked records. Trade experiences are linked across related business entities. All the trade data for a branch maintained at the branch but also rolled-up and associated with the headquarters for a unique identifier.

The DS component 314 computes new trade variables for a shorter time period, such as 3 months, instead of 12 months in conjunction with summarizer 212. The ATM 324 includes a monthly credit sales proxy variable equal to a sum of all aging categories like prompt, slow 30, slow 60 and the like minus the sum of all aging categories after the last prompt category for that experience.

The DS component 314 calculates PAYDEX scores using trade variables computed for shorter time periods (e.g., 3 months) rather than 12 months. In the example system, PAYDEX is calculated for 3-, 6-, 9-, 12-month periods for corresponding manner of payment periods. All the experiences in the DTW 200 are used for PAYDEX calculation, i.e. not available in AOS markings and reject flags are ignored. Also, the DS component calculates industry specific PAYDEX scores using SIC categories and credit-range specific PAYDEX scores.

The DS component 314 computes summarized elements for experiences in the DTW 200 similar to summarizer 212 but with additional computation for 3-, 6-, and 9-month summarized variables as well as 24-month high credit and manner of payment.

The PTM 322 is loaded and updated, stores data, and is purged. The detailed trade data and trade variables are loaded onto the PTM 322 periodically, such as on a weekly basis. The PTM 322 is kept in sync with the AOS trade database 108. Certain manual experiences and updates are loaded periodically, such as nightly. The PTM 322 stores data for matched records only. The PTM 322 stores the most current postings for an account and ensure removal of old data by purging periodically, such as monthly.

The ATM 324 is loaded and updated, stores data, and is purged similarly to the PTM 322. The detailed trade data and new calculated trade variables are loaded into the ATM 322 periodically, such as weekly. The ATM 322 need not be in sync with the AOS trade database 108. The ATM 324 stores data only for records having a unique identifier. The ATM 324 stores the most current postings for an account and ensures removal of old data by purging periodically, such as monthly.

1 The DQR 320 performs quality checks and generates the following reports in this example: detailed trade payment and banking report, detailed trade matrix report, load audit and statistics report, detailed trade inventory report, detailed trade unique identifier sweep report, detailed trade vta-sweep report. There are also a detailed trade maintenance and correction utility and a detailed trade calculated variables correction utility for the PTM 322.

The detailed trade system 300 also performs backups, schedules periodic jobs, determines availability and uptime, monitors performance, has recovery procedures, and maintains audit and log files.

FIGS. 4A, 4B, 4C, 4D, and 4E are example reports showing detailed payment experience generated using the detailed trade data and experiences.

It is to be understood that the above description is intended to be illustrative and not restrictive. Many other embodiments will be apparent to those of skill in the art upon reviewing the above description. Various designs using hardware, software, and firmware are contemplated by the present disclosure, even though some minor elements would need to change to better support the environments common to such systems and methods, such as various databases and programming languages. The present disclosure has applicability to fields other than business information. Therefore, the scope of the present disclosure should be determined with reference to the appended claims, along with the full scope of equivalents to which such claims are entitled.

1. A system for providing access to detailed payment experience, comprising:
at least one processor for capturing detailed trade data from a plurality of sources, calculating a plurality of summarized variables and a manner of payment and a high credit amount based on said detailed trade data, calculating a plurality of scores using said summarized variables, and providing a report using said detailed trade data, said plurality of summarized variables, and said plurality of scores; and
at least one storage device for storing and providing access to said detailed trade data, said plurality of summarized variables, and said plurality of scores.

2. The system according to claim 1, wherein said plurality of summarized variables is computed for a time period selected from the group consisting of: 3-months, 6-months, and 9-months.

3. The system according to claim 1, wherein said manner of payment and said high credit amount are calculated for a 24-month period.

4. The system according to claim 1, wherein said plurality of scores is calculated for a time period selected from the group consisting of: over a 3-months, 6-months, 9-months, 12-months, and 16-months.

5. A system for providing access to detailed payment experience, comprising:
a data acquisition component for capturing detailed trade data from a plurality of sources;
a data calculator for calculating a plurality summarized variables and a manner of payment and a high credit amount based on said detailed trade data;
a data synthesizer for calculating a plurality of scores using said summarized variables;
at least one storage device for storing and providing access to said detailed trade data, said plurality of summarized variables, and said plurality of scores; and
a reporter for providing a report using said detailed trade data, said plurality of summarized variables, and said plurality of scores.

6. The system according to claim 5, wherein said plurality of summarized variables is computed for a time period selected from the group consisting of: 3-months, 6-months, and 9-months.

7. The system according to claim 5, wherein said manner of payment and said high credit amount are calculated for a 24-month period.

8. The system according to claim 5, wherein said plurality of scores is calculated for a time period selected from the group consisting of: over a 3-months, 6-months, 9-months, 12-months, and 16-months.

9. The system according to claim 5, further comprising:
a data quality component for modifying data in said plurality of storage devices based on quality criteria.

10. The system according to claim 5, wherein said plurality of scores comprises an industry-specific score and a credit-range-specific score.

11. The system according to claim 5, wherein said storage device is at least one selected from the group consisting of: a detailed trade data warehouse, a product trade data mart; and an analytical trade data mart.

12. The system according to claim 5, wherein said report comprises data selected from the group consisting of: a summary, a dollar-weighted indicator of payment performance, a trend analysis, payment experiences and any combination thereof.

13. A method for providing access to detailed payment experience, comprising:
capturing detailed trade data from a plurality of sources;
calculating a plurality of summarized variables and a manner of payment and a high credit amount based on said detailed trade data;
calculating a plurality of scores using said summarized variables;
storing and providing access to said detailed trade data, said plurality of summarized variables, and said plurality of scores; and
providing a report using said detailed trade data, said plurality of summarized variables, and said plurality of scores.

14. The method according to claim 13, wherein said plurality of summarized variables is computed for a time period selected from the group consisting of: 3-months, 6-months, and 9-months.

15. The method according to claim 13, wherein said manner of payment and said high credit amount are calculated for a 24-month period.

16. The method according to claim 13, wherein said plurality of scores is calculated for a time period selected from the group consisting of: over a 3-months, 6-months, 9-months, 12-months, and 16-months.

17. The method according to claim 13, further comprising:
modifying data in said plurality of storage devices based on quality criteria.

18. The method according to claim 13, wherein said plurality of scores comprises an industry-specific score and a credit-range-specific score.

19. The method according to claim 13, wherein said storage device is at least one selected from the group consisting of: a detailed trade data warehouse, a product trade data mart; and an analytical trade data mart.

20. The method according to claim 13, wherein said report comprises data selected from the group consisting of: a summary, a dollar-weighted indicator of payment performance, a trend analysis, payment experiences, and any combination thereof.

21. A computer-readable medium having executable instructions stored thereon to perform a method for providing access to detailed payment experience, said method comprising:
capturing detailed trade data from a plurality of sources;
calculating a plurality of summarized variables and a manner of payment and a high credit amount based on said detailed trade data;
calculating a plurality of scores using said summarized variables;
storing and providing access to said detailed trade data, said plurality of summarized variables, and said plurality of scores; and
providing a report using said detailed trade data, said plurality of summarized variables, and said plurality of scores.

22. The method according to claim 21, wherein said plurality of summarized variables is computed for a time period selected from the group consisting of: 3-months, 6-months, and 9-months.

23. The method according to claim 21, wherein said manner of payment and said high credit amount are calculated for a 24-month period.

24. The method according to claim 21, wherein said plurality of scores is calculated for a time period selected from the group consisting of: over a 3-months, 6-months, 9-months, 12-months, and 16-months.
